(19) United States
(12) Patent Application Publication
(10) Pub. No.: US 2026/0212556 A1
(43) Pub. Date: Jul. 23, 2026

(54) CONTEXT-AWARE DYNAMIC PROFILE BACKGROUND

(71) Applicant: Snap Inc., Santa Monica, CA (US)

(72) Inventor: Suraya Shivji, New York, NY (US)

(21) Appl. No.: 19/033,854

(22) Filed: Jan. 22, 2025

(51) Int. Cl. G06T 11/60; G06F 3/04845; G06T 5/50

(52) U.S. Cl. CPC G06T 11/60; G06F 3/04845; G06T 5/50; G06T 2207/20221

(57) ABSTRACT

Systems and methods are provided for generating dynamic profile backgrounds in a social networking application. A system receives contextual data from a client device including location data, weather data, time data, and event data. The system generates a prompt by inserting contextual parameters into a parameterized prompt template and provides the prompt to a generative artificial intelligence model to generate a background image. The generated background image may be combined with visual effect overlays selected based on weather conditions or events. The system displays the background image with a graphical avatar in a user interface and updates the background on a rolling basis in response to changes in contextual data while adhering to update frequency limitations. The system may store pre-generated assets for major locations to reduce processing requirements and provides fallback behavior when location services are disabled.

### TECHNICAL FIELD

The present disclosure generally relates to computer-implemented systems and methods for generating and managing user interface elements in social networking applications. More specifically, the disclosure relates to techniques for dynamically modifying visual elements of user profiles based on contextual information and artificial intelligence.

### BACKGROUND

Social networking applications face significant technical challenges in maintaining user engagement with profile interfaces. One key challenge is the static nature of profile backgrounds, which typically remain unchanged for extended periods due to the manual effort required from users to update them.

The generation and management of profile visual elements presents technical difficulties in processing and combining multiple types of real-time data streams, including geolocation coordinates, weather information, and temporal data. Coordinating updates across these different data sources while maintaining system performance and user experience poses considerable engineering challenges.

Additionally, the computational resources required for real-time image generation and visual effects processing must be carefully managed to avoid degrading application performance. This is particularly challenging when implementing weather-based visual effects that need to be dynamically overlaid on existing interface elements.

Profile customization systems also face technical hurdles in gracefully handling interrupted data streams, such as when location services become unavailable or weather data cannot be retrieved. These scenarios require robust fallback mechanisms to maintain interface stability while preserving user preferences.

Furthermore, the processing and storage requirements for managing frequently updated visual elements across a large user base present significant scaling challenges. This includes the need to efficiently cache and serve dynamically generated content while maintaining acceptable response times and system resource utilization.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of a digital interaction system that has both client-side and server-side functionality, according to some examples.

FIG. 3 is a diagrammatic representation of a data structure as maintained in a database, according to some examples.

FIG. 4 is a diagrammatic representation of a message, according to some examples.

FIG. 5 is a flow diagram illustrating a method for generating and displaying dynamic profile backgrounds using contextual data and generative AI, according to certain examples.

FIG. 6 is a flow diagram illustrating a method for processing contextual data using parameterized prompt templates to generate prompts for dynamic background generation, according to certain examples.

FIG. 7 is a flow diagram illustrating a method for generating composite background images by combining AI-generated base images with contextual visual effect overlays, according to certain examples,

FIG. 8 is an interface diagram illustrating a graphical user interface (GUI) for displaying dynamic backgrounds with graphical avatars in a user profile interface, according to certain examples.

FIG. 9 is an interface diagram illustrating a GUI for selecting and enabling dynamic backgrounds, according to certain examples.

FIG. 10 illustrates an aspect of the subject matter in accordance with one embodiment.

FIG. 11 is a diagrammatic representation of a machine in the form of a computer system within which a set of instructions may be executed to cause the machine to perform any one or more of the methodologies discussed herein, according to some examples.

FIG. 12 is a block diagram showing a software architecture within which examples may be implemented.

### DETAILED DESCRIPTION

Social media users express their personality and identity through customizable profile pages that typically include a background image and an avatar. However, these profile backgrounds tend to remain static, requiring manual updates from users to reflect changes in their environment, location, or special occasions. The present disclosure describes systems and methods for automatically generating dynamic profile backgrounds that evolve based on a user's context, creating a more engaging and personalized social media experience.

According to certain examples, a social networking application monitors contextual data associated with a user's device, including the user's geographic location, local weather conditions, time of day, and special events. The system uses this contextual information to automatically generate and update profile backgrounds that reflect the user's current environment and circumstances.

For example, when a user is in New York City on a snowy winter morning, the system may generate a background depicting a representation of the NYC skyline with gently falling snow. Later that evening, the background smoothly transitions to show the same cityscape illuminated by night lighting, maintaining the snow effect to match the ongoing weather conditions.

According to certain examples, the system employs a generative artificial intelligence (AI) model to create these contextually-aware backgrounds. Rather than selecting from a limited set of pre-made images, the system dynamically, and routinely constructs prompts that describe the desired scene based on the user's current context. For example, these prompts may follow a consistent template structure, such as “Cartoon version of [Location] at [Time of Day]”, allowing the AI model to generate unique and personalized backgrounds.

In some examples, to enhance the generated background with dynamic elements, the system applies visual effect overlays based on real-time conditions. These overlays include weather effects like rain, snow, sunshine, or wind, as well as celebratory effects for special occasions such as birthdays, New Year's, or Valentine's Day.

The system intelligently manages updates to maintain a balance between dynamism and system resources. For example, in some examples, the background images update a maximum or minimum number of times per day (e.g., twice per day), while weather and event effects change in response to actual conditions. When a user visits their profile, they see their existing background smoothly fade into the new one, with a subtle notification indicating the change.

In some examples, for frequently accessed locations like major cities, the system maintains pre-generated assets to improve performance. However, the system can also generate unique backgrounds for any location, from small towns to college campuses, creating truly personalized experiences that reflect each user's specific environment.

To ensure a seamless user experience, the system includes fallback behaviors for various scenarios. For instance, if a user disables location services, rendering certain types of contextual data, such as location data, unavailable, the system may revert to their previous background and displays a temporary notification banner explaining the change.

In some examples, the system integrates with existing map functionality, utilizing the same location and weather data that powers the platform's map features. This integration ensures consistency across the application while leveraging existing data streams to drive the dynamic background generation.

Beyond simple background changes, the system creates opportunities for increased user engagement. Users can share their dynamic backgrounds, creating time-lapse-style videos that show how their profile evolves throughout the day or as they travel to different locations.

The system is designed to enhance the social media experience without requiring additional effort from users. Once enabled, the dynamic backgrounds automatically reflect the user's context, making profiles feel more alive and current without manual intervention.

This automated approach addresses the observation that while users have long had the ability to customize their profiles, only a small percentage regularly update their backgrounds or avatars. By automating these updates based on contextual data, the system brings profiles to life for all users, not just the most active customizers.

In some examples, the system's architecture separates background generation from effect overlays to create a composite background image with distinct portions. For example, the base background portion is generated by the generative AI model based on a subset of available contextual data, such as location data and time of day, creating scenes such as a representation of a specific city's skyline. An overlay portion may comprise pre-created visual effects that are selected and applied based on current weather conditions (rain, snow, sun, wind, smoke) or special events (birthdays, New Year's, Valentine's Day).

This two-portion architecture enables efficient background updates through selective modification. When weather conditions change, the system only needs to update the overlay portion by applying different weather effects while preserving the underlying base background image unchanged. Conversely, when a user's location changes, the system generates a new base background image through the generative AI model while maintaining any active weather or event effect overlays.

As an illustrative example, if a user is in New York during a snowfall, the base background portion would show a representation of the NYC skyline generated by the AI model, while the overlay portion would display pre-created snow effects. If the snow stops but the user remains in New York, only the snow overlay is removed while the NYC skyline background stays the same. If the user then travels to London while it's still snowing, the base background would be regenerated to show London's skyline, but the snow overlay effects would persist

In some examples, when the system generates a new background image using the generative AI model, the generated background image is presented among a collection of available background images for user selection. The system displays this collection through a backgrounds/poses screen that includes both static background options and the dynamically generated background.

The generated background may be presented as a special cell labeled “Dynamic” in the first row of backgrounds. When certain contextual data is available, such as for users with location enabled, this Dynamic cell displays additional contextual information including the city name, temperature, and current time of day-matching the information shown in the map header.

When presenting the generated background within the collection, the system stores the generated background image within a memory location of the client device. Users can then select the generated background from among the collection of images through an input selection process. Upon receiving the input that selects the generated background image from the collection, the system causes the display of the GUI with the graphical avatar displayed upon the selected generated background image.

In some examples, for major cities, the system may include pre-generated background assets in the collection to improve performance. These pre-generated backgrounds are stored and displayed alongside dynamically generated backgrounds, allowing users to choose between real-time generated options and optimized pre-rendered scenes.

### Networked Computing Environment

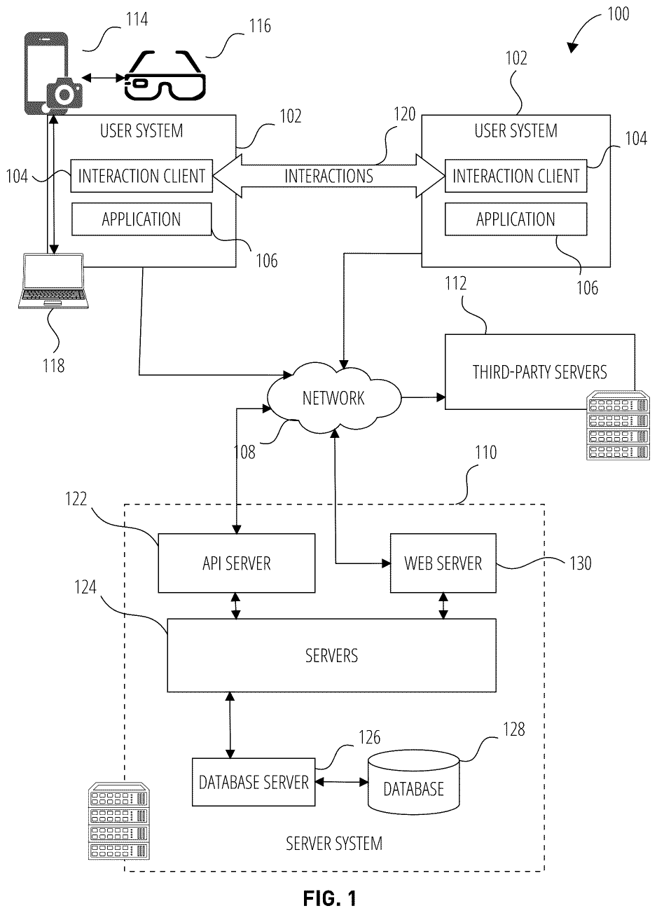

FIG. 1 is a block diagram showing an example digital interaction system 100 for facilitating interactions and engagements (e.g., exchanging text messages, conducting text audio and video calls, or playing games) over a network, including the generating and display of dynamic profile backgrounds. The digital interaction system 100 includes multiple user systems 102, each of which hosts multiple applications, including an interaction client 104 and other applications 106. Each interaction client 104 is communicatively coupled, via one or more networks including a network 108 (e.g., the Internet), to other instances of the interaction client 104 (e.g., hosted on respective other user systems 102), a server system 110 and third-party servers 112). An interaction client 104 can also communicate with locally hosted applications 106 using Applications Program Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the server system 110 via the network 108. The data exchanged between the interaction clients 104 (e.g., interactions 120) and between the interaction clients 104 and the server system 110 includes functions (e.g., commands to invoke functions) and payload data (e.g., text, audio, video, or other multimedia data).

The server system 110 provides server-side functionality via the network 108 to the interaction clients 104. While certain functions of the digital interaction system 100 are described herein as being performed by either an interaction client 104 or by the server system 110, the location of certain functionality either within the interaction client 104 or the server system 110 may be a design choice. For example, it may be technically preferable to initially deploy particular technology and functionality within the server system 110 but to later migrate this technology and functionality to the interaction client 104 where a user system 102 has sufficient processing capacity.

The server system 110 supports various services and operations that are provided to the interaction clients 104. Such operations include transmitting data to, receiving data from, and processing data generated by the interaction clients 104. This data may include message content, client device information, geolocation information, digital effects (e.g., media augmentation and overlays), message content persistence conditions, entity relationship information, and live event information. Data exchanges within the digital interaction system 100 are invoked and controlled through functions available via user interfaces (UIs) of the interaction clients 104. For example, the server system 110 may provide services that include: processing contextual data to generate appropriate prompts; operating the generative AI model to create background images; managing visual effect overlays based on weather and events; storing and serving pre-generated assets for major cities; monitoring trigger conditions for background updates; and managing transition effects between backgrounds.

According to certain examples, the server system 110 may include one or more databases for storing generated backgrounds, visual effect overlays, prompt templates, and user preferences. For example, for major cities or specific locations of interest, the database may maintain collections of pre-generated backgrounds and visual effect overlays to improve system performance.

Turning now specifically to the server system 110, an Application Program Interface (API) server 122 is coupled to and provides programmatic interfaces to servers 124, making the functions of the servers 124 accessible to interaction clients 104, other applications 106 and third-party server 112. The servers 124 are communicatively coupled to a database server 126, facilitating access to a database 128 that stores data associated with interactions processed by the servers 124. Similarly, a web server 130 is coupled to the servers 124 and provides web-based interfaces to the servers 124. To this end, the web server 130 processes incoming network requests over the Hypertext Transfer Protocol (HTTP) and several other related protocols.

The Application Program Interface (API) server 122 receives and transmits interaction data (e.g., commands and message payloads) between the servers 124 and the user systems 102 (and, for example, interaction clients 104 and other application 106) and the third-party server 112. Specifically, the Application Program Interface (API) server 122 provides a set of interfaces (e.g., routines and protocols) that can be called or queried by the interaction client 104 and other applications 106 to invoke functionality of the servers 124. The Application Program Interface (API) server 122 exposes various functions supported by the servers 124, including account registration; login functionality; the sending of interaction data, via the servers 124, from a particular interaction client 104 to another interaction client 104; the communication of media files (e.g., images or video) from an interaction client 104 to the servers 124; the settings of a collection of media data (e.g., a narrative); the retrieval of a list of friends of a user of a user system 102; the retrieval of messages and content; the addition and deletion of entities (e.g., friends) to an entity relationship graph (e.g., the entity graph 308); the location of friends within an entity relationship graph; and opening an application event (e.g., relating to the interaction client 104).

In some examples, the Application Program Interface (API) server 122 provides interfaces for the client applications to: submit contextual data; request background generation; access visual effect overlays; retrieve pre-generated backgrounds; configure update preferences; and manage background collections.

In some examples, the client applications provide user interfaces for: displaying the dynamic backgrounds with overlaid avatars; presenting collections of available backgrounds; selecting backgrounds from collections; viewing transition effects between backgrounds; and receiving notifications about background updates

In some examples, the system architecture separates the generation and storage of base background images from the application of visual effect overlays, enabling efficient updates when only weather conditions change while maintaining consistent base imagery.

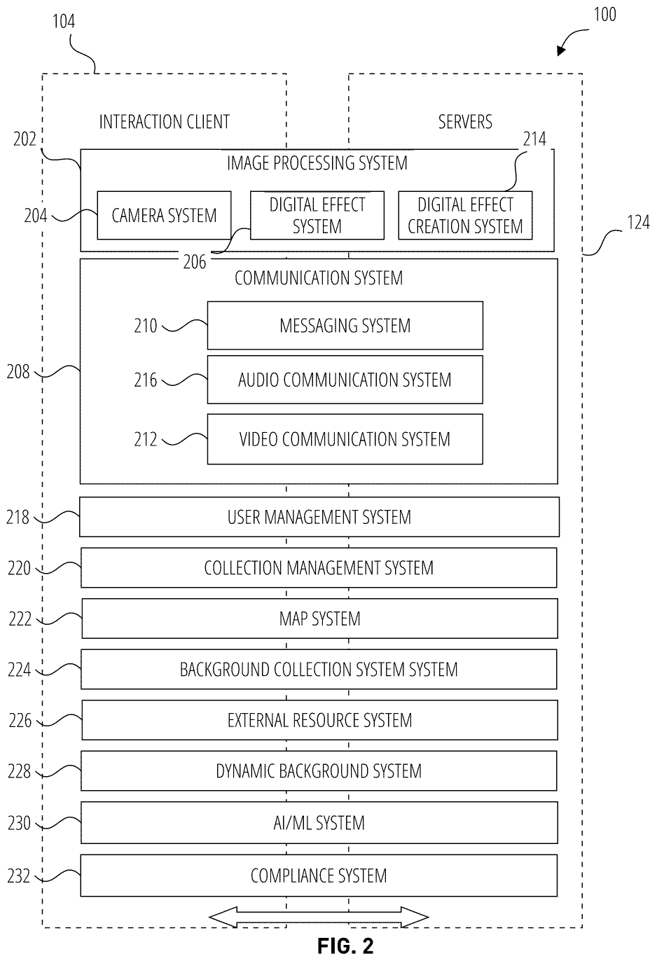

The servers 124 host multiple systems and subsystems, described below with reference to FIG. 2.

### System Architecture

FIG. 2 is a block diagram illustrating further details regarding the digital interaction system 100, according to some examples. Specifically, the digital interaction system 100 is shown to comprise the interaction client 104 and the servers 124. The digital interaction system 100 embodies multiple subsystems, which are supported on the client-side by the interaction client 104 and on the server-side by the servers 124. In some examples, these subsystems are implemented as microservices. A microservice subsystem (e.g., a microservice application) may have components that enable it to operate independently and communicate with other services. Example components of microservice subsystem may include:
Function logic: The function logic implements the functionality of the microservice subsystem, representing a specific capability or function that the microservice provides.
API interface: Microservices may communicate with each other components through well-defined APIs or interfaces, using lightweight protocols such as REST or messaging. The API interface defines the inputs and outputs of the microservice subsystem and how it interacts with other microservice subsystems of the digital interaction system 100.
Data storage: A microservice subsystem may be responsible for its own data storage, which may be in the form of a database, cache, or other storage mechanism (e.g., using the database server 126 and database 128). This enables a microservice subsystem to operate independently of other microservices of the digital interaction system 100.
Service discovery: Microservice subsystems may find and communicate with other microservice subsystems of the digital interaction system 100. Service discovery mechanisms enable microservice subsystems to locate and communicate with other microservice subsystems in a scalable and efficient way.
Monitoring and logging: Microservice subsystems may need to be monitored and logged to ensure availability and performance. Monitoring and logging mechanisms enable the tracking of health and performance of a microservice subsystem.

In some examples, the digital interaction system 100 may employ a monolithic architecture, a service-oriented architecture (SOA), a function-as-a-service (FaaS) architecture, or a modular architecture:

Example subsystems are discussed below.

An image processing system 202 provides various functions that enable a user to capture and modify (e.g., augment, annotate or otherwise edit) media content associated with a message.

A camera system 204 includes control software (e.g., in a camera application) that interacts with and controls hardware camera hardware (e.g., directly or via operating system controls) of the user system 102 to modify real-time images captured and displayed via the interaction client 104.

The digital effect system 206 provides functions related to the generation and publishing of digital effects (e.g., media overlays) for images captured in real-time by cameras of the user system 102 or retrieved from memory of the user system 102. For example, the digital effect system 206 operatively selects, presents, and displays digital effects (e.g., media overlays such as image filters or modifications) to the interaction client 104 for the modification of real-time images received via the camera system 204 or stored images retrieved from memory 1102 of a user system 102. These digital effects are selected by the digital effect system 206 and presented to a user of an interaction client 104, based on a number of inputs and data, such as for example:
Geolocation of the user system 102; and
Entity relationship information of the user of the user system 102.

Digital effects may include audio and visual content and visual effects. Examples of audio and visual content include pictures, texts, logos, animations, and sound effects. Examples of visual effects include color overlays and media overlays. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The digital effect creation system 214 supports augmented reality developer platforms and includes an application for content creators (e.g., artists and developers) to create and publish digital effects (e.g., augmented reality experiences) of the interaction client 104. The digital effect creation system 214 provides a library of built-in features and tools to content creators including, for example custom shaders, tracking technology, and templates.

In some examples, the digital effect creation system 214 provides a merchant-based publication platform that enables merchants to select a particular digital effect associated with a geolocation via a bidding process. For example, the digital effect creation system 214 associates a media overlay of the highest bidding merchant with a corresponding geolocation for a predefined amount of time.

A communication system 208 is responsible for enabling and processing multiple forms of communication and interaction within the digital interaction system 100 and includes a messaging system 210, an audio communication system 216, and a video communication system 212. The messaging system 210 is responsible, in some examples, for enforcing the temporary or time-limited access to content by the interaction clients 104. The messaging system 210 incorporates multiple timers that, based on duration and display parameters associated with a message or collection of messages (e.g., a narrative), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 218 is operationally responsible for the management of user data and profiles, and maintains entity information (e.g., stored in entity tables 306, entity graphs 308 and profile data 302) regarding users and relationships between users of the digital interaction system 100.

A collection management system 220 is operationally responsible for managing sets or collections of media (e.g., collections of text, image video, and audio data). A collection of content (e.g., messages, including images, video, text, and audio) may be organized into an “event gallery” or an “event collection.” Such a collection may be made available for a specified time period, such as the duration of an event to which the content relates. For example, content relating to a music concert may be made available as a “concert collection” for the duration of that music concert. The collection management system 220 may also be responsible for publishing an icon that provides notification of a particular collection to the user interface of the interaction client 104. The collection management system 220 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 220 employs machine vision (or image recognition technology) and content rules to curate a content collection automatically. In certain examples, compensation may be paid to a user to include user-generated content into a collection. In such cases, the collection management system 220 operates to automatically make payments to such users to use their content.

A map system 222 provides various geographic location (e.g., geolocation) functions and supports the presentation of map-based media content and messages by the interaction client 104. For example, the map system 222 enables the display of user icons or avatars (e.g., stored in profile data 302) on a map to indicate a current or past location of “friends” of a user, as well as media content (e.g., collections of messages including photographs and videos) generated by such friends, within the context of a map. For example, a message posted by a user to the digital interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the digital interaction system 100 via the interaction client 104, with this location and status information being similarly displayed within the context of a map interface of the interaction client 104 to selected users.

The background collection system system 224 provides functionality for managing and presenting collections of dynamic and static background images within the digital interaction system. The system organizes and stores background options while providing intuitive user access through a dedicated backgrounds/poses interface.

The background collection system system 224 manages collections of available background images, including both generated dynamic backgrounds and static options, presenting them through a backgrounds/poses screen interface. A special “Dynamic” cell spans double width in the first row of backgrounds, enhanced with contextual information like city name, temperature, and current time for users with location enabled.

In some examples, the background collection system system 224 stores and organizes pre-generated background assets for frequently accessed locations like major cities. It maintains generated background images within device memory locations while managing weather and event effect overlays. The system employs caching strategies for commonly accessed backgrounds to ensure smooth user experience.

Users may interact with backgrounds through a browsable collection interface that enables selection from available options. The background collection system system 224 receives user input for background selection and triggers the display of selected backgrounds with user avatars in the profile interface. Visual previews help users evaluate different background options before making a selection.

In some examples, working within a modular architecture, the background collection system system 224 may interface with multiple components, including: the Image Processing System 202 for background processing and overlay application, the Dynamic Background System 228 for receiving newly generated backgrounds, the Map System 222 for obtaining location data, and the Artificial Intelligence System 230 for background generation An external resource system 226 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the servers 124. The SDK includes Application Programming Interfaces (APIs) with functions that can be called or invoked by the web-based application. The servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A bridge script running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to servers 124. The servers 124 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

A dynamic background system 228 is responsible for generating and managing contextually-aware profile backgrounds. The system interfaces with several other components shown in FIG. 2, including the: Image Processing System 202—for processing and modifying generated background images and applying visual effect overlays to create composite background images; Map System 222—to obtain location data and geographic information used in generating location-specific backgrounds; Artificial Intelligence and Machine Learning System 230—powers the generative AI model that creates background images based on parameterized prompts incorporating contextual data.

According to certain examples, the dynamic background system 228 performs several key functions that may include: processing contextual data including location, weather, and time to generate appropriate prompts; interfacing with the AI system to generate base background images; managing pre-created visual effect overlays for weather and events; controlling background update frequency and transitions; maintaining collections of pre-generated backgrounds for major cities; and handling fallback behaviors when location services are disabled.

In some examples, the system employs a modular architecture that separates background generation from effect overlays, working with the Image Processing System 202 to combine base backgrounds with visual effects. It interfaces with the Map System 222 to obtain location data and the AI System 230 to generate location-specific imagery through parameterized prompts.

An artificial intelligence and machine learning system 230 provides a variety of services to different subsystems within the digital interaction system 100. For example, the artificial intelligence and machine learning system 230 operates with the image processing system 202 and the camera system 204 to analyze images and extract information such as objects, text, or faces. This information can then be used by the image processing system 202 to enhance, filter, or manipulate images. The artificial intelligence and machine learning system 230 may be used by the digital effect system 206 to generate modified content and augmented reality experiences, such as adding virtual objects or animations to real-world images. The communication system 208 and messaging system 210 may use the artificial intelligence and machine learning system 230 to analyze communication patterns and provide insights into how users interact with each other and provide intelligent message classification and tagging, such as categorizing messages based on sentiment or topic. The artificial intelligence and machine learning system 230 may also provide chatbot functionality to message interactions 120 between user systems 102 and between a user system 102 and the server system 110. The artificial intelligence and machine learning system 230 may also work with the audio communication system 216 to provide speech recognition and natural language processing capabilities, allowing users to interact with the digital interaction system 100 using voice commands.

A compliance system 232 facilitates compliance by the digital interaction system 100 with data privacy and other regulations, including for example the California Consumer Privacy Act (CCPA), General Data Protection Regulation (GDPR), and Digital Services Act (DSA). The compliance system 232 comprises several components that address data privacy, protection, and user rights, ensuring a secure environment for user data. A data collection and storage component securely handles user data, using encryption and enforcing data retention policies. A data access and processing component provides controlled access to user data, ensuring compliant data processing and maintaining an audit trail. A data subject rights management component facilitates user rights requests in accordance with privacy regulations, while the data breach detection and response component detects and responds to data breaches in a timely and compliant manner. The compliance system 232 also incorporates opt-in/opt-out management and privacy controls across the digital interaction system 100, empowering users to manage their data preferences. The compliance system 232 is designed to handle sensitive data by obtaining explicit consent, implementing strict access controls and in accordance with applicable laws.

### Data Architecture

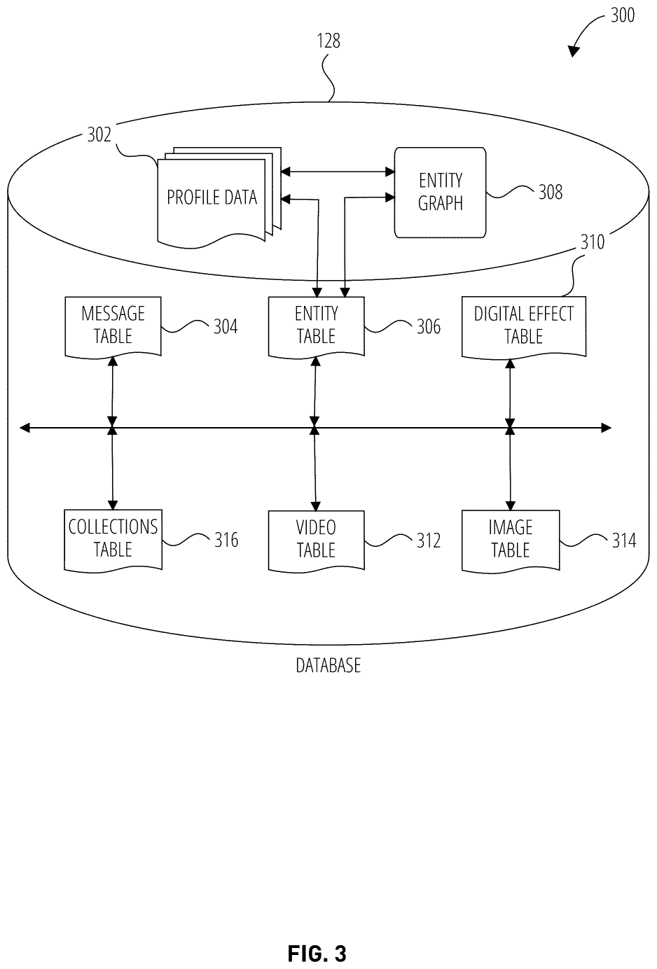

FIG. 3 is a schematic diagram illustrating data structures 300, which may be stored in the database 128 of the server system 110, according to certain examples. While the content of the database 128 is shown to comprise multiple tables, it will be appreciated that the data could be stored in other types of data structures (e.g., as an object-oriented database).

The database 128 includes message data stored within a message table 304. This message data includes at least message sender data, message recipient (or receiver) data, and a payload. Further details regarding information that may be included in a message, and included within the message data stored in the message table 304, are described below with reference to FIG. 3.

An entity table 306 stores entity data, and is linked (e.g., referentially) to an entity graph 308 and profile data 302. Entities for which records are maintained within the entity table 306 may include individuals, corporate entities, organizations, objects, places, events, and so forth. Regardless of entity type, any entity regarding which the server system 110 stores data may be a recognized entity. Each entity is provided with a unique identifier, as well as an entity type identifier (not shown).

The entity graph 308 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the digital interaction system 100.

Certain permissions and relationships may be attached to each relationship, and to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 306. Such privacy settings may be applied to all types of relationships within the context of the digital interaction system 100, or may selectively be applied to certain types of relationships.

The profile data 302 stores multiple types of profile data about a particular entity. The profile data 302 may be selectively used and presented to other users of the digital interaction system 100 based on privacy settings specified by a particular entity. Where the entity is an individual, the profile data 302 includes, for example, a username, telephone number, address, settings (e.g., notification and privacy settings), as well as a user-selected avatar representation (or collection of such avatar representations). A particular user may then selectively include one or more of these avatar representations within the content of messages communicated via the digital interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 302 for the group may similarly include one or more avatar representations associated with the group, in addition to the group name, members, and various settings (e.g., notifications) for the relevant group.

The database 128 also stores digital effect data, such as overlays or filters, in a digital effect table 310. The digital effect data is associated with and applied to videos (for which data is stored in a video table 312) and images (for which data is stored in an image table 314).

In some examples, the database 128 also includes a background data table that stores data related to dynamic profile backgrounds. This table maintains records of generated background images, including base background images and their associated visual effect overlays. Each background record includes:
Generated base background image data
Associated contextual data (location, weather, time)
Visual effect overlay references
Background update parameters and timing information
Pre-generated background assets for major cities

The background data table links to the profile data 302, allowing each user profile to reference its current dynamic background configuration. The table also maintains relationships with the digital effect table 310 for accessing weather and event effect overlays that can be applied to base background images.

In some examples, for performance optimization, the background data table includes fields for caching frequently accessed backgrounds and storing pre-generated assets for popular locations. The table also maintains metadata about background generation parameters, including prompt templates and contextual data mappings.

The background data records include timestamps and trigger conditions that determine when backgrounds should be updated based on changes in contextual data. These records also track user preferences for background selection and update frequency.

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other digital effect data that may be stored within the image table 314 includes augmented reality content items (e.g., corresponding to augmented reality experiences). An augmented reality content item may be a real-time special effect and sound that may be added to an image or a video.

A collections table 316 stores data regarding collections of messages and associated image, video, or audio data, which are compiled into a collection (e.g., a narrative or a gallery). The creation of a particular collection may be initiated by a particular user (e.g., each user for which a record is maintained in the entity table 306). A user may create a “personal collection” in the form of a collection of content that has been created and sent/broadcast by that user. To this end, the user interface of the interaction client 104 may include an icon that is user-selectable to enable a sending user to add specific content to his or her personal narrative.

A collection may also constitute a “live collection,” which is a collection of content from multiple users that is created manually, automatically, or using a combination of manual and automatic techniques. For example, a “live collection” may constitute a curated stream of user-submitted content from various locations and events. Users whose client devices have location services enabled and are at a common location event at a particular time may, for example, be presented with an option, via a user interface of the interaction client 104, to contribute content to a particular live collection. The live collection may be identified to the user by the interaction client 104, based on his or her location.

A further type of content collection is known as a “location collection,” which enables a user whose user system 102 is located within a specific geographic location (e.g., on a college or university campus) to contribute to a particular collection. In some examples, a contribution to a location collection may employ a second degree of authentication to verify that the end-user belongs to a specific organization or other entity (e.g., is a student on the university campus).

As mentioned above, the video table 312 stores video data that, in some examples, is associated with messages for which records are maintained within the message table 304. Similarly, the image table 314 stores image data associated with messages for which message data is stored in the entity table 306. The entity table 306 may associate various digital effects from the digital effect table 310 with various images and videos stored in the image table 314 and the video table 312.

### Data Communications Architecture

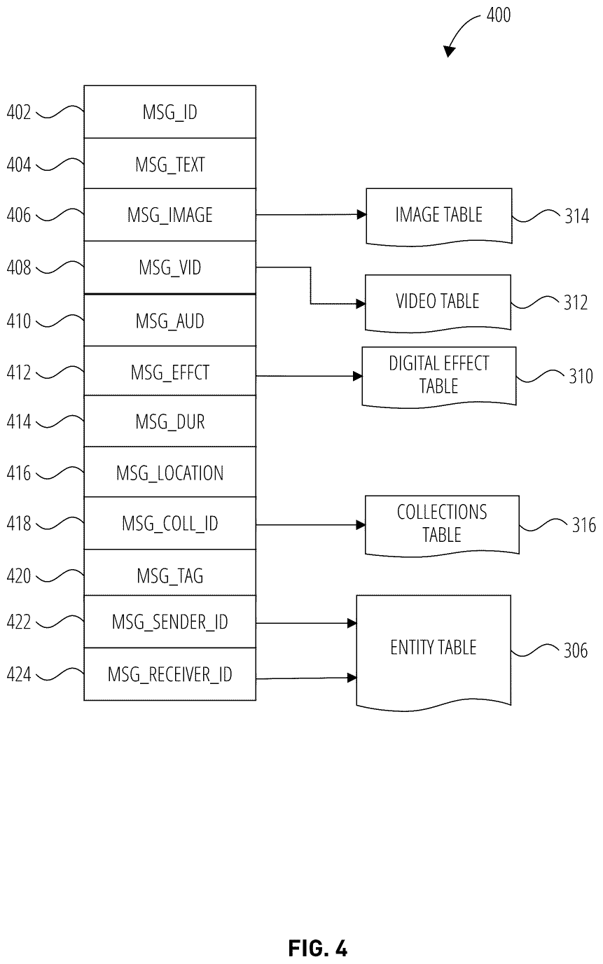

FIG. 4 is a schematic diagram illustrating a structure of a message 400, according to some examples, generated by an interaction client 104 for communication to a further interaction client 104 via the servers 124. The content of a particular message 400 is used to populate the message table 304 stored within the database 128, accessible by the servers 124. Similarly, the content of a message 400 is stored in memory as “in-transit” or “in-flight” data of the user system 102 or the servers 124. A message 400 is shown to include the following example components:
Message identifier 402: a unique identifier that identifies the message 400.
Message text payload 404: text, to be generated by a user via a user interface of the user system 102, and that is included in the message 400.
Message image payload 406: image data, captured by a camera component of a user system 102 or retrieved from a memory component of a user system 102, and that is included in the message 400. Image data for a sent or received message 400 may be stored in the image table 314.
Message video payload 408: video data, captured by a camera component or retrieved from a memory component of the user system 102, and that is included in the message 400. Video data for a sent or received message 400 may be stored in the video table 312.
Message audio payload 410: audio data, captured by a microphone or retrieved from a memory component of the user system 102, and that is included in the message 400.
Message digital effect data 412: digital effect data (e.g., filters, stickers, or other annotations or enhancements) that represents digital effects to be applied to message image payload 406, message video payload 408, or message audio payload 410 of the message 400. Digital effect data for a sent or received message 400 may be stored in the digital effect table 310.
Message duration parameter 414: parameter value indicating, in seconds, the amount of time for which content of the message (e.g., the message image payload 406, message video payload 408, message audio payload 410) is to be presented or made accessible to a user via the interaction client 104.
Message geolocation parameter 416: geolocation data (e.g., latitudinal, and longitudinal coordinates) associated with the content payload of the message. Multiple message geolocation parameter 416 values may be included in the payload, each of these parameter values being associated with respect to content items included in the content (e.g., a specific image within the message image payload 406, or a specific video in the message video payload 408).
Message collection identifier 418: identifier values identifying one or more content collections (e.g., “stories” identified in the collections table 316) with which a particular content item in the message image payload 406 of the message 400 is associated. For example, multiple images within the message image payload 406 may each be associated with multiple content collections using identifier values.
Message tag 420: each message 400 may be tagged with multiple tags, each of which is indicative of the subject matter of content included in the message payload. For example, where a particular image included in the message image payload 406 depicts an animal (e.g., a lion), a tag value may be included within the message tag 420 that is indicative of the relevant animal. Tag values may be generated manually, based on user input, or may be automatically generated using, for example, image recognition.
Message sender identifier 422: an identifier (e.g., a messaging system identifier, email address, or device identifier) indicative of a user of the user system 102 on which the message 400 was generated and from which the message 400 was sent.
Message receiver identifier 424: an identifier (e.g., a messaging system identifier, email address, or device identifier) indicative of a user of the user system 102 to which the message 400 is addressed.

The contents (e.g., values) of the various components of message 400 may be pointers to locations in tables within which content data values are stored. For example, an image value in the message image payload 406 may be a pointer to (or address of) a location within an image table 314. Similarly, values within the message video payload 408 may point to data stored within a video table 312, values stored within the message digital effect data 412 may point to data stored in a digital effect table 310, values stored within the message collection identifier 418 may point to data stored in a collections table 316, and values stored within the message sender identifier 422 and the message receiver identifier 424 may point to user records stored within an entity table 306.

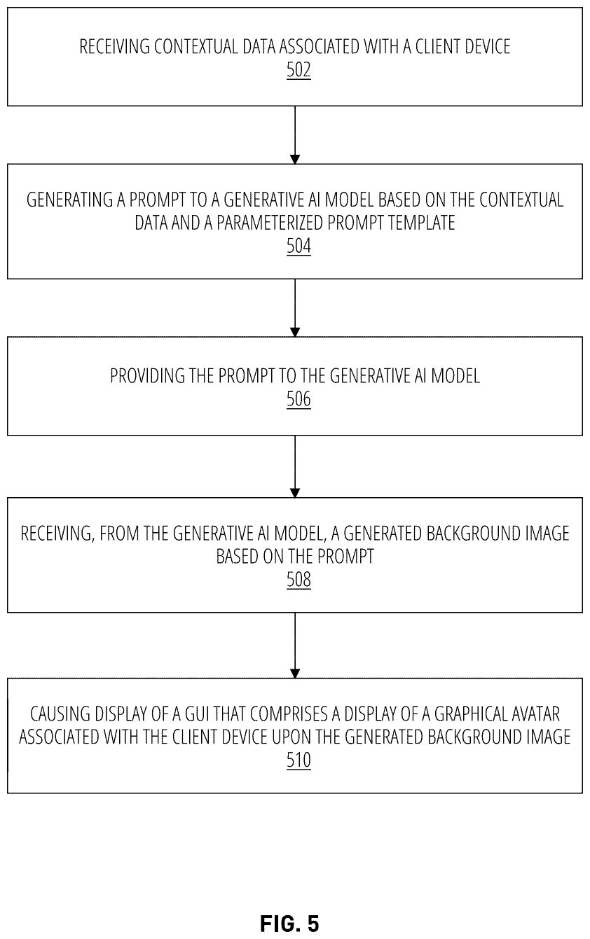

FIG. 5 is a flow diagram illustrating a method for generating and displaying dynamic profile backgrounds using contextual data and generative AI, according to certain examples.

At operation 502, the system receives contextual data associated with a client device. This contextual data may include location data indicating a geographic location of the client device, weather data associated with the geographic location (including rain conditions, snow conditions, sun conditions, wind conditions, and smoke conditions), and temporal data indicating the current time of day at the geographic location.

The contextual data may be accessed in response to detecting trigger conditions, such as an expiration of a temporal period or a change in location data from the client device. For example, the system may detect various trigger conditions to determine when contextual data should be accessed and processed for dynamic background updates. When monitoring time-based conditions, the system implements scheduled background updates that occur no more than twice per day, while also managing special 24-hour duration triggers for events like birthdays, New Years, and Valentine's Day. The system additionally tracks time of day changes to ensure backgrounds appropriately reflect different lighting conditions and temporal scenes throughout the day.

In some examples, the contextual data may further comprise biometric data, when authorized by the user, including: expression data (facial expressions, hand gestures, body movements); biosignal measurements (heart rate, body temperature); identity verification data (facial identification, voice identification).

For location-based contextual updates, the system may continuously or routinely monitor location data generated by the client device's location services (when enabled by a user) to detect when users move to new geographic locations or cities. This includes tracking entry and exit from predefined geographic boundaries such as college campuses or landmarks, as well as changes in the user's current neighborhood that would necessitate different location specific backgrounds.

Weather-based trigger monitoring may involve tracking changes in current weather conditions including rain, snow, sun, wind, and smoke conditions. For example, the system may interface with weather data services to receive updates about changing conditions and transitions between different weather states that require new effect overlays to be applied to the background.

When a trigger condition is detected, the system initiates a coordinated response that includes accessing the latest contextual data from relevant services, updating stored contextual parameters in the system, and initiating the background generation process if updates are determined to be needed. The system then manages smooth transitions between existing backgrounds and newly generated ones to maintain a seamless user experience.

At operation 504, the system generates a prompt for a generative AI model by accessing a parameterized prompt template based on the received contextual data. The system inserts the contextual data into corresponding fields of the parameterized prompt template.

For example, the prompt template may follow the format “Cartoon version of [User's Location] at [time of day]” with the bracketed fields being populated with the actual location and time data. The system may maintain different prompt templates optimized for generating backgrounds for different types of locations, such as major cities, college campuses, or landmarks.

At operation 506, the system provides the generated prompt to the generative AI model. The generative AI model may be part of the artificial intelligence and machine learning system that provides various services within the digital interaction system.

The system interfaces with the AI model through defined APIs to request generation of background images based on the parameterized prompts.

At operation 508, the system receives a generated background image from the generative AI model based on the provided prompt. The generated background image may comprise a base image and a visual effect overlay.

The system may access the visual effect overlay from a repository based on the contextual data and combine it with the base image to create the final generated background image. The system may store the generated background image within a memory location of the client device for efficient access.

At operation 510, the system causes display of a graphical user interface that presents the graphical avatar associated with the client device displayed upon the generated background image. The system may first present the generated background image among a collection of images and receive user input selecting the generated background before displaying it with the avatar.

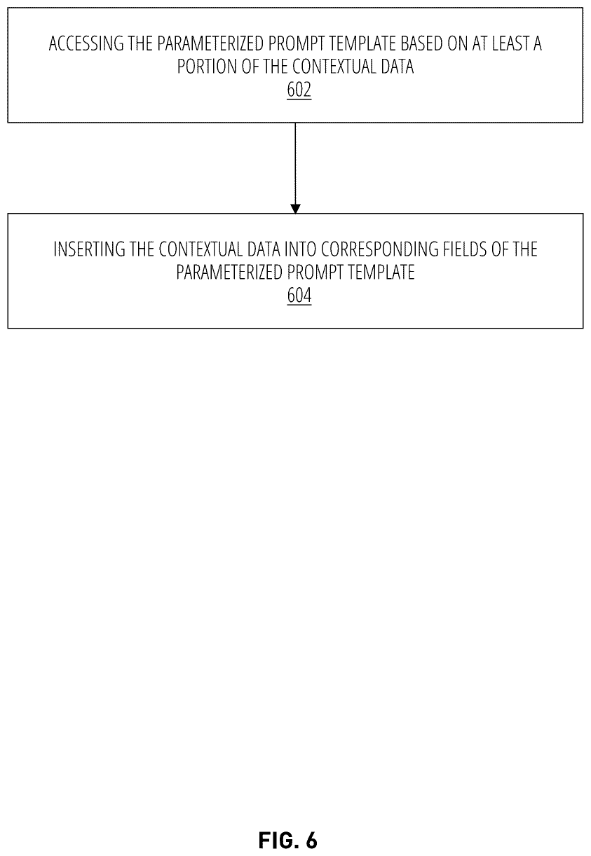

FIG. 6 is a flow diagram illustrating a method for processing contextual data using parameterized prompt templates to generate prompts for dynamic background generation. The method includes accessing appropriate prompt templates based on contextual parameters and populating template fields with the contextual data to create complete prompts for the generative AI system.

At operation 602, the system accesses a parameterized prompt template based on the received contextual data. For example, the system may maintain different prompt templates optimized for various scenarios and location types. For major cities, the system may use templates designed to capture iconic skylines and landmarks, while templates for college campuses may focus on characteristic campus features. The template selection is driven by analyzing the contextual data, including the location type, time of day, and current weather conditions. For example, the system may use different base templates for daytime versus nighttime scenes, or templates specifically designed for weather conditions like snow or rain, or templates specifically designed for specific locations of interest and events/event types.

At operation 604, the system inserts the contextual data from the client device into corresponding fields of the selected parameterized prompt template. For example, the template may contain placeholder fields that are populated with specific contextual parameters to create a complete prompt. For example, a basic template may follow the format “Cartoon version of [User's Location] at [time of day]” where the system inserts the actual location name and current time into the bracketed fields. For more complex templates, the system may insert multiple contextual parameters including specific weather conditions, seasonal information, and detailed location characteristics. The system processes the contextual data to ensure proper formatting and compatibility with the template structure before insertion. For frequently accessed locations like major cities, the system may use pre-validated parameter combinations to optimize prompt generation and ensure consistent results.

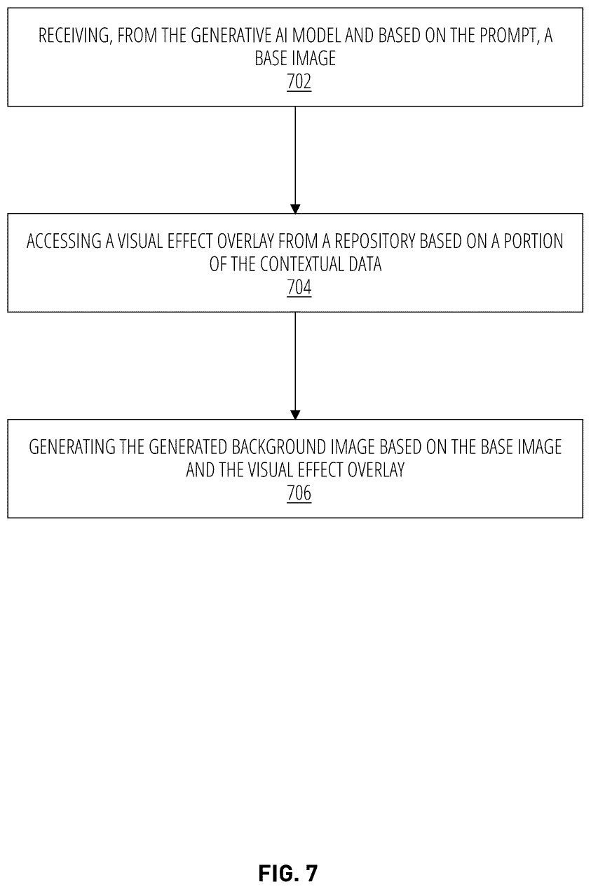

FIG. 7 is a flow diagram illustrating a method for generating composite background images by combining AI-generated base images with contextual visual effect overlays, according to certain examples. The method includes receiving a base image from the generative AI model, accessing appropriate visual effects based on contextual parameters, and combining these elements to create a dynamic background image.

At operation 702, the system receives a base background image generated by the AI model in response to the parameterized prompt. The base image incorporates the fundamental scene elements specified in the prompt, such as location-specific features, time-of-day lighting, and seasonal characteristics. For major cities, these base images may capture iconic skylines and architectural elements, while campus locations may feature characteristic academic buildings and grounds. The system validates the received base image to ensure it meets quality requirements and contains the expected visual elements based on the provided prompt.

At operation 704, the system accesses appropriate visual effect overlays from a repository based on the contextual data. These overlays include weather effects (rain, snow, sun, wind, smoke) and event-specific effects (birthday, New Year's, Valentine's Day). The system maintains a collection of pre-created effect overlays that are standardized across all users to ensure consistent visual quality. The selection of specific overlays is driven by analyzing the contextual data-for example, accessing rain effect overlays when weather data indicates precipitation, or retrieving celebratory overlays during special events. The system may also combine multiple overlays when multiple contextual conditions apply simultaneously.

At operation 706, the system generates the final background image by combining the base image with the selected visual effect overlays. This process involves sophisticated image processing to ensure proper alignment and blending of the overlays with the base image. The system applies appropriate transparency and opacity settings to create natural-looking weather effects, and positions event-specific overlays in visually appealing locations within the composition. For frequently accessed locations like major cities, the system may optimize this process by maintaining pre-computed parameters for overlay positioning and blending. The final composite image is then stored in the client device's memory for efficient access during display.

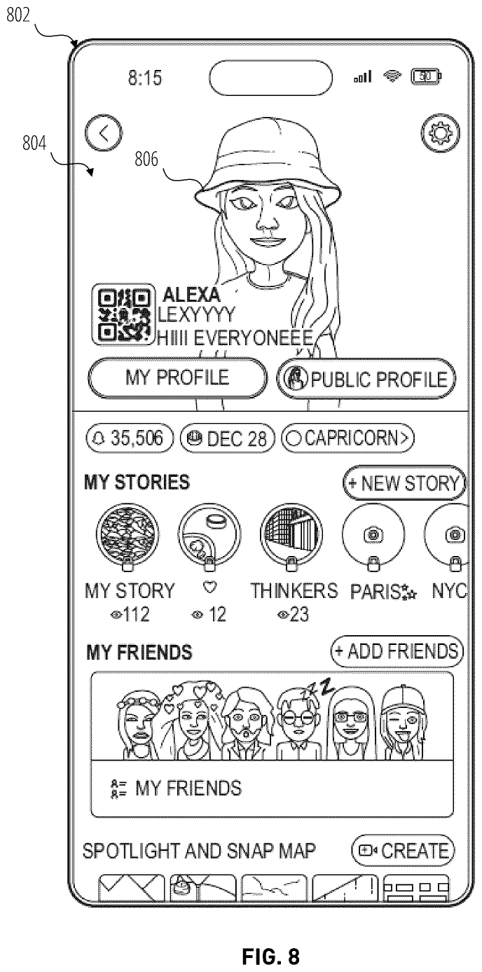

FIG. 8 is an interface diagram illustrating a graphical user interface (GUI) for displaying dynamic backgrounds with graphical avatars in a user profile interface. As seen in FIG. 8, the background 804 is shown in an initial empty state before content selection or presentation.

According to certain examples, the GUI 802 comprises a profile interface that includes a dynamic background 804 to dynamically display generated background images according to user profile information. As seen in FIG. 8, the dynamic background 804 is shown in its default empty state to illustrate the base interface structure before any background content is selected or generated.

Positioned within the GUI 802 is a graphical avatar 806 that represents the user's personalized character or profile image. The avatar 806 is displayed as an overlay element that will persist above any selected background content, maintaining its visibility and prominence in the interface regardless of the background displayed behind it.

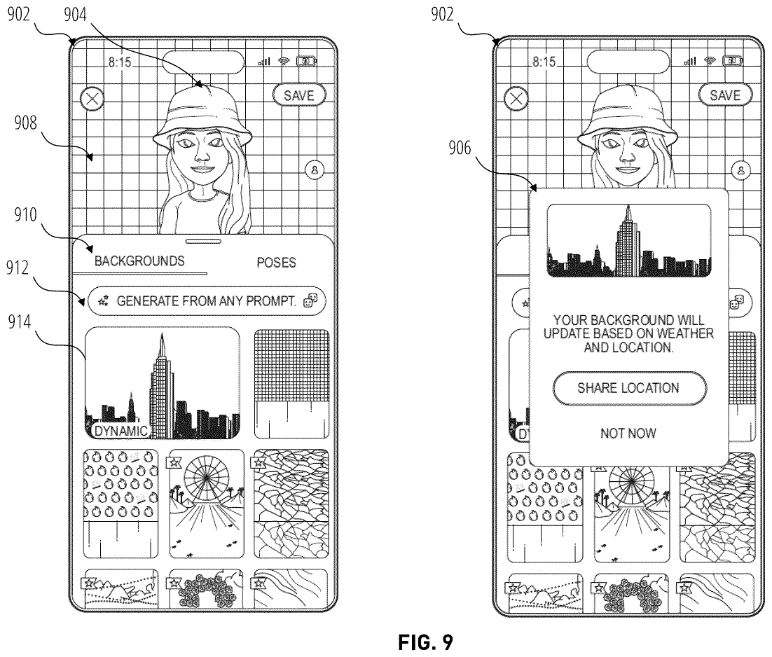

FIG. 9 is an interface diagram illustrating a GUI 902 for selecting and enabling dynamic backgrounds, including the initial permission request flow for accessing required contextual data, according to certain examples.

As seen in FIG. 9, the GUI 902 may include a display of a background selection interface that includes a dynamic background region 908 where generated backgrounds may appear. A graphical avatar 904 is positioned as an overlay element that will be displayed on top of the selected or generated background content. The interface includes a menu element 910 to present a set of background options 912, and includes the dynamic background option 914 which allows users to enable the automatic background generation feature.

According to certain examples, when a user selects the dynamic background option 914, the system displays a notification dialogue 906 that includes a request for necessary permissions. The notification 906 informs users that backgrounds will update based on weather and location data, and includes options for enabling location services if not already activated. For users without location enabled, this dialogue serves as the primary entry point for activating the dynamic backgrounds feature by granting the required location permissions.

In some examples, the dynamic background option 914 includes a dynamically generated icon which may be based on the user's location. For major cities, the icon displays city-specific imagery like recognizable landmarks or skylines. In some examples, the system maintains different icon assets for each main city and generates these using the same generative AI system that creates the backgrounds. The icon includes contextual information like the city name, temperature, and time of day when location services are enabled.

As an illustrative example, when a user selects the dynamic background option 914, the system displays a notification dialogue 906 that includes a request for necessary permissions. The notification 906 informs users that backgrounds will update based on weather and location data, and includes options for enabling location services if not already activated. For users without location enabled, this dialogue serves as the primary entry point for activating the dynamic backgrounds feature by granting the required location permissions. The notification presents two clear options: “Share Location” which triggers the system location permissions dialogue, or “Not Now” which maintains current settings. If location services are later disabled after selecting dynamic backgrounds, the system will fall back to the user's previous background and display a temporary warning banner indicating the dynamic feature was disabled.

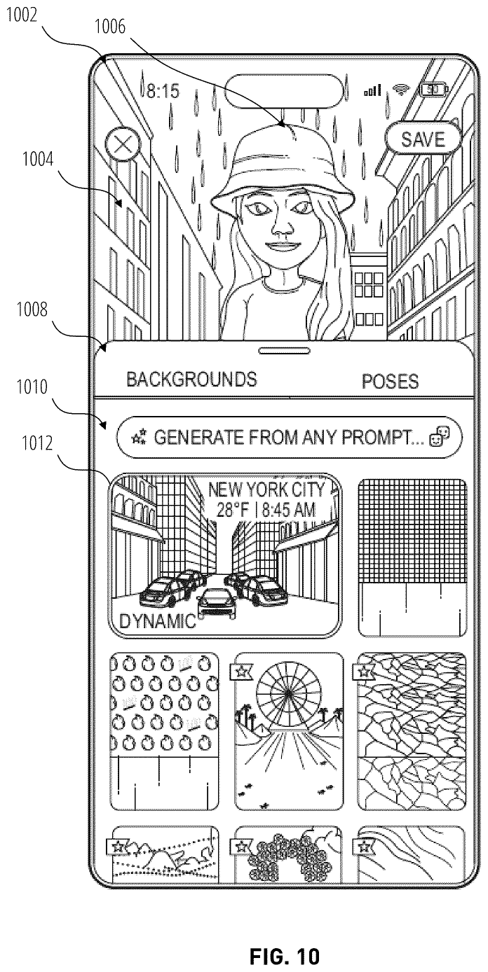

FIG. 10 is an interface diagram illustrating a GUI 1002 for displaying and selecting dynamic backgrounds, including the presentation of contextual information within the background selection interface, according to certain examples.

The GUI 1002 displays a background selection interface that includes a dynamic background region 1004 where generated backgrounds will appear. According to certain examples, a graphical avatar 1006 may be positioned as an overlay element that maintains visibility above any selected background content. The interface includes a menu element 1008 to present a set of background options 1010, that includes the dynamic background option 1012.

According to certain examples, the dynamic background option 1012 may include a display of contextual information such as “NEW YORK CITY 28° F.|8:45 AM”, demonstrating how the system surfaces location, weather, and temporal data directly in the background selection interface.

For users with location enabled, the dynamic background option includes location specific imagery generated using the system's generative AI capabilities. The background preview shows a stylized representation of the user's current location, incorporating weather effects and time-of-day lighting conditions. In some examples, the system may maintain a database of different background assets for major cities while generating custom backgrounds for other locations using parameterized prompts that capture the essential characteristics of each location.

### Machine Architecture

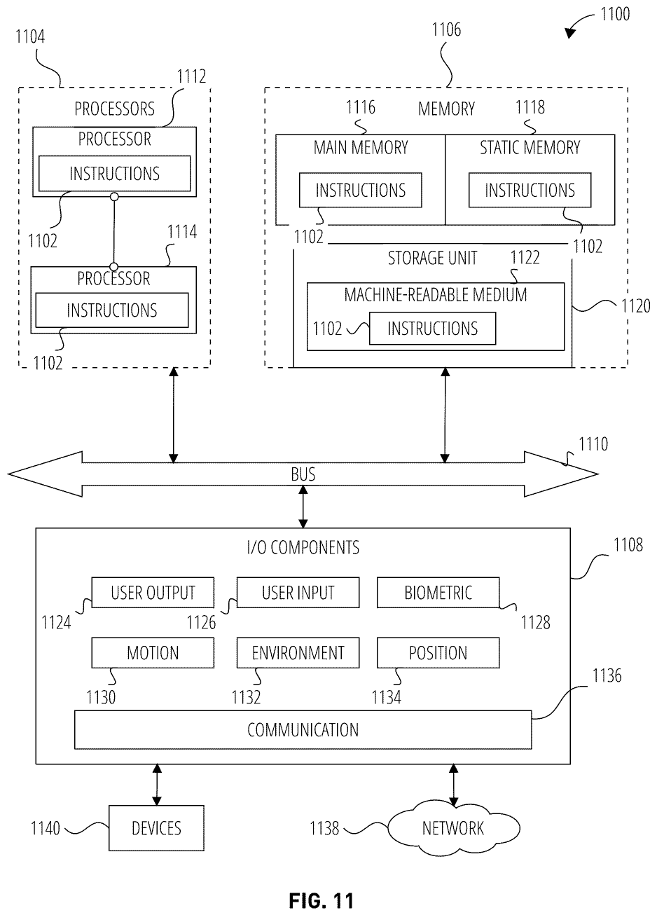

FIG. 11 is a diagrammatic representation of the machine 1100 within which instructions 1102 (e.g., software, a program, an application, an applet, an app, or other executable code) for causing the machine 1100 to perform any one or more of the methodologies discussed herein may be executed. For example, the instructions 1102 may cause the machine 1100 to execute any one or more of the methods described herein. The instructions 1102 transform the general, non-programmed machine 1100 into a particular machine 1100 programmed to carry out the described and illustrated functions in the manner described. The machine 1100 may operate as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1102, sequentially or otherwise, that specify actions to be taken by the machine 1100. Further, while a single machine 1100 is illustrated, the term “machine” shall also be taken to include a collection of machines that individually or jointly execute the instructions 1102 to perform any one or more of the methodologies discussed herein. The machine 1100, for example, may comprise the user system 102 or any one of multiple server devices forming part of the server system 110. In some examples, the machine 1100 may also comprise both client and server systems, with certain operations of a particular method or algorithm being performed on the server-side and with certain operations of the method or algorithm being performed on the client-side.

The machine 1100 may include Processors 1104, memory 1106, and input/output I/O components 1108, which may be configured to communicate with each other via a bus 1110.

The memory 1106 includes a main memory 1116, a static memory 1118, and a storage unit 1120, both accessible to the Processors 1104 via the bus 1110. The main memory 1106, the static memory 1118, and storage unit 1120 store the instructions 1102 embodying any one or more of the methodologies or functions described herein. The instructions 1102 may also reside, completely or partially, within the main memory 1116, within the static memory 1118, within machine-readable medium 1122 within the storage unit 1120, within at least one of the Processors 1104 (e.g., within the processor's cache memory), or any suitable combination thereof, during execution thereof by the machine 1100.

The I/O components 1108 may include a wide variety of components to receive input, provide output, produce output, transmit information, exchange information, capture measurements, and so on. The specific I/O components 1108 that are included in a particular machine will depend on the type of machine. For example, portable machines such as mobile phones may include a touch input device or other such input mechanisms, while a headless server machine will likely not include such a touch input device. It will be appreciated that the I/O components 1108 may include many other components that are not shown in FIG. 11. In various examples, the I/O components 1108 may include user output components 1124 and user input components 1126. The user output components 1124 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1126 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1108 may include biometric components 1128, motion components 1130, environmental components 1132, or position components 1134, among a wide array of other components. For example, the biometric components 1128 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored only with user approval and deleted on user request, and in accordance with applicable laws. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the data is not shared or sold to any third party without the explicit consent of the user. In addition, appropriate technical and organizational measures are implemented to ensure the security and confidentiality of this sensitive information.

The motion components 1130 include acceleration sensor components (e.g., accelerometer), gravitation sensor components, rotation sensor components (e.g., gyroscope).

The environmental components 1132 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be modified with digital effect data (e.g., filters) described above. The rear cameras may, for example, be used to capture still images and videos in a more traditional camera mode, with these images similarly being modified with digital effect data. In addition to front and rear cameras, the user system 102 may also include a 360° camera for capturing 360° photographs and videos.

Moreover, the camera system of the user system 102 may be equipped with advanced multi-camera configurations. This may include dual rear cameras, which might consist of a primary camera for general photography and a depth-sensing camera for capturing detailed depth information in a scene. This depth information can be used for various purposes, such as creating a bokeh effect in portrait mode, where the subject is in sharp focus while the background is blurred. In addition to dual camera setups, the user system 102 may also feature triple, quad, or even penta camera configurations on both the front and rear sides of the user system 102. These multiple cameras systems may include a wide camera, an ultra-wide camera, a telephoto camera, a macro camera, and a depth sensor, for example.

Communication may be implemented using a wide variety of technologies. The I/O components 1108 further include communication components 1136 operable to couple the machine 1100 to a Network 1138 or devices 1140 via respective coupling or connections. For example, the communication components 1136 may include a network interface component or another suitable device to interface with the Network 1138. In further examples, the communication components 1136 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1140 may be another machine or any of a wide variety of peripheral devices (e.g., a peripheral device coupled via a USB).

Moreover, the communication components 1136 may detect identifiers or include components operable to detect identifiers. For example, the communication components 1136 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1136, such as location via Internet Protocol (IP) geolocation, location via Wi-Fi® signal triangulation, location via detecting an NFC beacon signal that may indicate a particular location, and so forth.

The various memories (e.g., main memory 1116, static memory 1118, and memory of the Processors 1104) and storage unit 1120 may store one or more sets of instructions and data structures (e.g., software) embodying or used by any one or more of the methodologies or functions described herein. These instructions (e.g., the instructions 1102), when executed by Processors 1104, cause various operations to implement the disclosed examples.

The instructions 1102 may be transmitted or received over the Network 1138, using a transmission medium, via a network interface device (e.g., a network interface component included in the communication components 1136) and using any one of several well-known transfer protocols (e.g., hypertext transfer protocol (HTTP)). Similarly, the instructions 1102 may be transmitted or received using a transmission medium via a coupling (e.g., a peer-to-peer coupling) to the devices 1140.

### Software Architecture

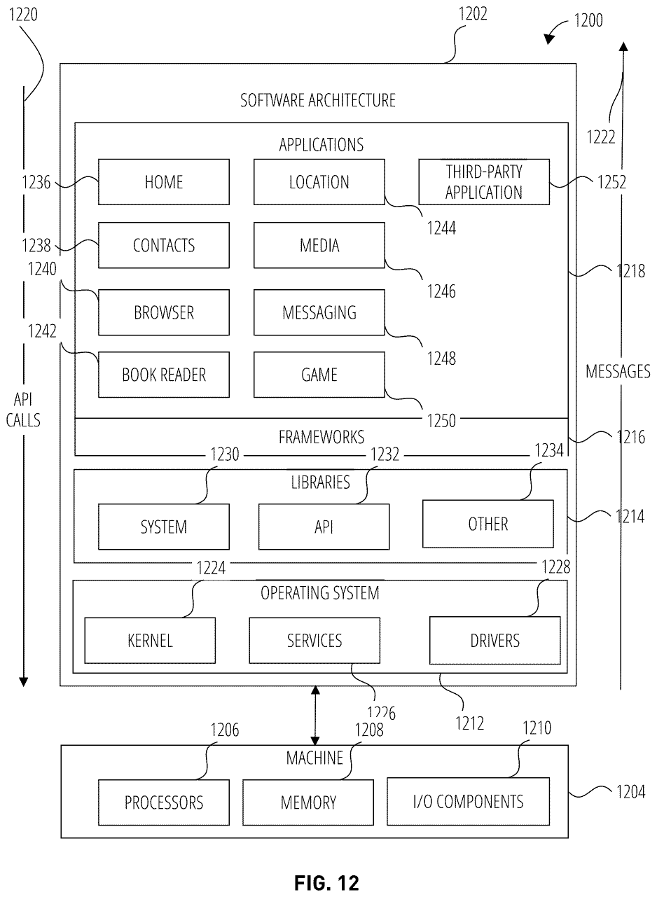

FIG. 12 is a block diagram 1200 illustrating a software architecture 1202, which can be installed on any one or more of the devices described herein. The software architecture 1202 is supported by hardware such as a machine 1204 that includes Processors 1206, memory 1208, and I/O components 1210. In this example, the software architecture 1202 can be conceptualized as a stack of layers, where each layer provides a particular functionality. The software architecture 1202 includes layers such as an operating system 1212, libraries 1214, frameworks 1216, and applications 1218. Operationally, the applications 1218 invoke API calls 1220 through the software stack and receive messages 1222 in response to the API calls 1220.

The operating system 1212 manages hardware resources and provides common services. The operating system 1212 includes, for example, a kernel 1224, services 1226, and drivers 1228. The kernel 1224 acts as an abstraction layer between the hardware and the other software layers. For example, the kernel 1224 provides memory management, processor management (e.g., scheduling), component management, networking, and security settings, among other functionalities. The services 1226 can provide other common services for the other software layers. The drivers 1228 are responsible for controlling or interfacing with the underlying hardware. For instance, the drivers 1228 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1214 provide a common low-level infrastructure used by the applications 1218. The libraries 1214 can include system libraries 1230 (e.g., C standard library) that provide functions such as memory allocation functions, string manipulation functions, mathematical functions, and the like. In addition, the libraries 1214 can include API libraries 1232 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1214 can also include a wide variety of other libraries 1234 to provide many other APIs to the applications 1218.

The frameworks 1216 provide a common high-level infrastructure that is used by the applications 1218. For example, the frameworks 1216 provide various graphical user interface (GUI) functions, high-level resource management, and high-level location services. The frameworks 1216 can provide a broad spectrum of other APIs that can be used by the applications 1218, some of which may be specific to a particular operating system or platform.

In an example, the applications 1218 may include a home application 1236, a contacts application 1238, a browser application 1240, a book reader application 1242, a location application 1244, a media application 1246, a messaging application 1248, a game application 1250, and a broad assortment of other applications such as a third-party application 1252. The applications 1218 are programs that execute functions defined in the programs. Various programming languages can be employed to create one or more of the applications 1218, structured in a variety of manners, such as object-oriented programming languages (e.g., Objective-C, Java, or C++) or procedural programming languages (e.g., C or assembly language). In a specific example, the third-party application 1252 (e.g., an application developed using the ANDROID™ or IOS™ software development kit (SDK) by an entity other than the vendor of a platform) may be mobile software running on a mobile operating system such as IOS™, ANDROID™, WINDOWS® Phone, or another mobile operating system. In this example, the third-party application 1252 can invoke the API calls 1220 provided by the operating system 1212 to facilitate functionalities described herein.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any portions of this application. Where the context permits, words using the singular or plural number may also include the plural or singular number respectively.

The word “or” in reference to a list of two or more items, covers all the following interpretations of the word: any one of the items in the list, all the items in the list, and any combination of the items in the list. Likewise, the term “and/or” in reference to a list of two or more items, covers all the following interpretations of the word: any one of the items in the list, all the items in the list, and any combination of the items in the list.

The various features, operations, or processes described herein may be used independently of one another, or may be combined in various ways. All possible combinations and sub-combinations are intended to fall within the scope of this disclosure. In addition, certain method or process blocks may be omitted in some implementations.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

### EXAMPLE STATEMENTS

Example 1 is a method comprising receiving contextual data associated with a client device; generating a prompt to a generative artificial intelligence (AI) model based on the contextual data and a parameterized prompt template; providing the prompt to the generative AI model; receiving, from the generative AI model, a generated background image based on the prompt; and causing display of a graphical user interface (GUI) that comprises a display of a graphical avatar associated with the client device displayed upon the generated background image.

In Example 2, the subject matter of Example 1, wherein generating the prompt comprises accessing the parameterized prompt template based on at least a portion of the contextual data and inserting the contextual data into corresponding fields of the parameterized prompt template.

In Example 3, the subject matter of Example 1 and 2, wherein the contextual data comprises location data that indicates a geographic location of the client device; weather data associated with the geographic location, wherein the weather data indicates at least one of rain conditions, snow conditions, sun conditions, wind conditions, and smoke conditions; and temporal data that indicates a current time of day at the geographic location.

In Example 4, the subject matter of Examples 1-3, wherein the generated background image comprises a base image and a visual effect overlay, and wherein receiving the generated background image comprises receiving the base image from the generative AI model; accessing the visual effect overlay from a repository based on a portion of the contextual data; and generating the generated background image based on the base image and the visual effect overlay.

In Example 5, the subject matter of Examples 1-4, wherein receiving the contextual data from the client device further comprises detecting a trigger condition and accessing the contextual data from the client device responsive to the trigger condition.

In Example 6, the subject matter of Example 5, wherein the trigger condition includes one or more of an expiration of a temporal period and a change in location data from the client device.

In Example 7, the subject matter of Examples 1-6, wherein receiving, from the generative AI model, the generated background image based on the prompt further comprises storing the generated background image within a memory location of the client device.

In Example 8, the subject matter of Examples 1-7, wherein causing display of the GUI that comprises the display of the graphical avatar associated with the client device upon the generated background image further comprises presenting the generated background image among a collection of images; receiving an input that selects the generated background image from among the collection of images; and causing display of the GUI that comprises the display of the graphical avatar associated with the client device upon the generated background image responsive to the input that selects the generated background image.

In Example 9, the subject matter of Examples 1-8 implemented as a system comprising one or more processors and a memory comprising instructions which, when executed by the one or more processors, cause the one or more processors to perform the operations.

In Example 10, the subject matter of Example 9, wherein generating the prompt comprises accessing the parameterized prompt template based on at least a portion of the contextual data and inserting the contextual data into corresponding fields of the parameterized prompt template.

In Example 11, the subject matter of Example 9, wherein the contextual data comprises location data that indicates a geographic location of the client device; weather data associated with the geographic location, wherein the weather data indicates at least one of rain conditions, snow conditions, sun conditions, wind conditions, and smoke conditions; and temporal data that indicates a current time of day at the geographic location.

In Example 12, the subject matter of Examples 9-11, wherein the generated background image comprises a base image and a visual effect overlay, and wherein receiving the generated background image comprises receiving the base image from the generative AI model; accessing the visual effect overlay from a repository based on a portion of the contextual data; and generating the generated background image based on the base image and the visual effect overlay.

In Example 13, the subject matter of Examples 9-12, wherein receiving the contextual data from the client device further comprises detecting a trigger condition and accessing the contextual data from the client device responsive to the trigger condition.

In Example 14, the subject matter of Example 13, wherein the trigger condition includes one or more of an expiration of a temporal period and a change in location data from the client device.

In Example 15, the subject matter of Examples 9-14, wherein receiving, from the generative AI model, the generated background image based on the prompt further comprises storing the generated background image within a memory location of the client device.

In Example 16, the subject matter of Examples 9-15, wherein causing display of the GUI that comprises the display of the graphical avatar associated with the client device upon the generated background image further comprises presenting the generated background image among a collection of images; receiving an input that selects the generated background image from among the collection of images; and causing display of the GUI that comprises the display of the graphical avatar associated with the client device upon the generated background image responsive to the input that selects the generated background image.

In Example 17, the subject matter of Examples 1-16 implemented as a non-transitory machine-readable storage medium comprising instructions that, when executed by one or more processors of a machine, cause the machine to perform the operations.

In Example 18, the subject matter of Example 17, wherein generating the prompt comprises accessing the parameterized prompt template based on at least a portion of the contextual data and inserting the contextual data into corresponding fields of the parameterized prompt template.

In Example 19, the subject matter of Example 17, wherein the contextual data comprises location data that indicates a geographic location of the client device; weather data associated with the geographic location, wherein the weather data indicates at least one of rain conditions, snow conditions, sun conditions, wind conditions, and smoke conditions; and temporal data that indicates a current time of day at the geographic location.

In Example 20, the subject matter of Examples 17-19, wherein the generated background image comprises a base image and a visual effect overlay, and wherein receiving the generated background image comprises receiving the base image from the generative AI model; accessing the visual effect overlay from a repository based on a portion of the contextual data; and generating the generated background image based on the base image and the visual effect overlay.

Example 21 may include an apparatus comprising means to perform one or more elements of a method described in or related to any of Examples 1-20 or any other method or process described herein.

Example 22 may include one or more non-transitory computer-readable media comprising instructions to cause an electronic device, upon execution of the instructions by one or more processors of the electronic device, to perform one or more elements of a method described in or related to any of Examples 1-21, or any other method or process described herein.

Example 23 may include an apparatus comprising logic, modules, or circuitry to perform one or more elements of a method described in or related to any of Examples 1-22 or any other method or process described herein.

Example 24 may include a method, technique, or process as described in or related to any of Examples 1-23 or portions or parts thereof.

Example 25 may include an apparatus comprising one or more processors and one or more computer-readable media comprising instructions that, when executed by the one or more processors, cause the one or more processors to perform the method, techniques, or process as described in or related to any of Examples 1-24, or portions thereof.

Example 26 may include a signal as described in or related to any of Examples 1-25, or portions or parts thereof.

Example 27 may include a datagram, packet, frame, segment, protocol data unit (PDU), or message as described in or related to any of Examples 1-26, or portions or parts thereof, or otherwise described in the present disclosure.

Example 28 may include a signal encoded with data as described in or related to any of Examples 1-27, or portions or parts thereof, or otherwise described in the present disclosure.

Example 29 may include a signal encoded with a datagram, packet, frame, segment, protocol data unit (PDU), or message as described in or related to any of Examples 1-28, or portions or parts thereof, or otherwise described in the present disclosure.

Example 30 may include an electromagnetic signal carrying computer-readable instructions, wherein execution of the computer-readable instructions by one or more processors is to cause the one or more processors to perform the method, techniques, or process as described in or related to any of Examples 1-29, or portions thereof.

Example 31 may include a computer program comprising instructions, wherein execution of the program by a processing element is to cause the processing element to carry out the method, techniques, or process as described in or related to any of Examples 1-30, or portions thereof.

Example 32 may include a signal in a wireless network, as shown and described herein.

Example 33 may include a method of communicating in a wireless network as shown and described herein.

Example 34 may include a system for providing wireless communication, as shown and described herein.

Example 35 may include a device for providing wireless communication as shown and described herein.

### TERM EXAMPLES

“Carrier signal” may include, for example, any intangible medium that can store, encoding, or carrying instructions for execution by the machine and includes digital or analog communications signals or other intangible media to facilitate communication of such instructions. Instructions may be transmitted or received over a network using a transmission medium via a network interface device.

“Client device” may include, for example, any machine that interfaces to a network to obtain resources from one or more server systems or other client devices. A client de vice may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Component” may include, for example, a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” may refer to a hardware component implemented using one or more processors. Similarly, the methods described herein may be at least partially Processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” may include, for example, both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” may include, for example, a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media, and device-storage media include non-volatile memory, including by way of example semiconductor memory devices, e.g., erasable programmable read-only memory (EPROM), electrically erasable programmable read-only memory (EEPROM), Field-Programmable Gate Arrays (FPGA), flash memory devices, Solid State Drives (SSD), and Non-Volatile Memory Express (NVMe) devices; magnetic disks such as internal hard disks and removable disks; magneto-optical disks; and CD-ROM, DVD-ROM, Blu-ray Discs, and Ultra HD Blu-ray discs. In addition, machine storage medium may also refer to cloud storage services, Network Attached Storage (NAS), Storage Area Networks (SAN), and object storage devices. The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Network” may include, for example, one or more portions of a network that may be an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Area Network (MAN), the Internet, a portion of the Internet, a portion of the Public Switched Telephone Network (PSTN), a Voice over IP (VOIP) network, a cellular telephone network, a 5G™ network, a wireless network, a Wi-Fi® network, a Wi-Fi 6® network, a Li-Fi network, a Zigbee® network, a Bluetooth® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as third Generation Partnership Project (3GPP) including 4G, fifth-generation wireless (5G) networks, Universal Mobile Telecommunications System (UMTS), High Speed Packet Access (HSPA), Long Term Evolution (LTE) standard, others defined by various standard-setting organizations, other long-range protocols, or other data transfer technology.

“Non-transitory computer-readable storage medium” may include, for example, a tangible medium that is capable of storing, encoding, or carrying the instructions for execution by a machine.

“Processor” may include, for example, data processors such as a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), a Quantum Processing Unit (QPU), a Tensor Processing Unit (TPU), a Neural Processing Unit (NPU), a Field Programmable Gate Array (FPGA), another processor, or any suitable combination thereof. The term “processor” may include multi-core processors that may comprise two or more independent processors (sometimes referred to as “cores”) that may execute instructions contemporaneously. These cores can be homogeneous (e.g., all cores are identical, as in multicore CPUs) or heterogeneous (e.g., cores are not identical, as in many modern GPUs and some CPUs). In addition, the term “processor” may also encompass systems with a distributed architecture, where multiple processors are interconnected to perform tasks in a coordinated manner. This includes cluster computing, grid computing, and cloud computing infrastructures. Furthermore, the processor may be embedded in a device to control specific functions of that device, such as in an embedded system, or it may be part of a larger system, such as a server in a data center. The processor may also be virtualized in a software-defined infrastructure, where the processor's functions are emulated in software.

“Signal medium” may include, for example, an intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” may include, for example, a device accessed, controlled or owned by a user and with which the user interacts perform an action, engagement or interaction on the user device, including an interaction with other users or computer systems.

What is claimed is:

1. A system comprising:
at least one processor;
at least one memory component storing instructions that, when executed by the at least one processor, cause the at least one processor to perform operations comprising:
receiving contextual data associated with a client device;
generating a prompt to a generative artificial intelligence (AI) model based on the contextual data and a parameterized prompt template;
providing the prompt to the generative AI model;
receiving, from the generative AI model, a generated background image based on the prompt; and
causing display of a graphical user interface (GUI) that comprises a display of a graphical avatar associated with the client device displayed upon the generated background image.

2. The system of claim 1, wherein the generating the prompt comprises:
accessing the parameterized prompt template based on at least a portion of the contextual data; and
inserting the contextual data into corresponding fields of the parameterized prompt template.

3. The system of claim 1, wherein the contextual data comprises:
location data that indicates a geographic location of the client device;
weather data associated with the geographic location, wherein the weather data indicates at least one of rain conditions, snow conditions, sun conditions, wind conditions, and smoke conditions; and
temporal data that indicates a current time of day at the geographic location.

4. The system of claim 1, wherein the generated background image comprises a base image and a visual effect overlay, and wherein the receiving the generated background image comprises:
receiving the base image from the generative AI model;
accessing the visual effect overlay from a repository based on a portion of the contextual data; and
generating the generated background image based on the base image and the visual effect overlay.

5. The system of claim 1, wherein the receiving the contextual data from the client device further comprises:
detecting a trigger condition; and
accessing the contextual data from the client device responsive to the trigger condition.

6. The system of claim 5, wherein the trigger condition includes one or more of:
an expiration of a temporal period; and
a change in location data from the client device.

7. The system of claim 1, wherein the receiving, from the generative AI model, the generated background image based on the prompt further comprises:
storing the generated background image within a memory location of the client device.

8. The system of claim 1, wherein the causing display of the GUI that comprises the display of the graphical avatar associated with the client device upon the generated background image further comprises:
presenting the generated background image among a collection of images;
receiving an input that selects the generated background image from among the collection of images; and
causing display of the GUI that comprises the display of the graphical avatar associated with the client device upon the generated background image responsive to the input that selects the generated background image.

9. A computer-implemented method comprising:
receiving contextual data associated with a client device;
generating a prompt to a generative artificial intelligence (AI) model based on the contextual data and a parameterized prompt template;
providing the prompt to the generative AI model;
receiving, from the generative AI model, a generated background image based on the prompt; and
causing display of a graphical user interface (GUI) that comprises a display of a graphical avatar associated with the client device displayed upon the generated background image.

10. The computer-implemented method of claim 9, wherein the generating the prompt comprises:
accessing the parameterized prompt template based on at least a portion of the contextual data; and
inserting the contextual data into corresponding fields of the parameterized prompt template.

11. The computer-implemented method of claim 9, wherein the contextual data comprises:
location data that indicates a geographic location of the client device;
weather data associated with the geographic location, wherein the weather data indicates at least one of rain conditions, snow conditions, sun conditions, wind conditions, and smoke conditions; and
temporal data that indicates a current time of day at the geographic location.

12. The computer-implemented method of claim 9, wherein the generated background image comprises a base image and a visual effect overlay, and wherein the receiving the generated background image comprises:
receiving the base image from the generative AI model;
accessing the visual effect overlay from a repository based on a portion of the contextual data; and
generating the generated background image based on the base image and the visual effect overlay.

13. The computer-implemented method of claim 9, wherein the receiving the contextual data from the client device further comprises:
detecting a trigger condition; and
accessing the contextual data from the client device responsive to the trigger condition.

14. The computer-implemented method of claim 13, wherein the trigger condition includes one or more of:
an expiration of a temporal period; and
a change in location data from the client device.

15. The computer-implemented method of claim 9, wherein the receiving, from the generative AI model, the generated background image based on the prompt further comprises:
storing the generated background image within a memory location of the client device.

16. The computer-implemented method of claim 9, wherein the causing display of the GUI that comprises the display of the graphical avatar associated with the client device upon the generated background image further comprises:
presenting the generated background image among a collection of images;
receiving an input that selects the generated background image from among the collection of images; and
causing display of the GUI that comprises the display of the graphical avatar associated with the client device upon the generated background image responsive to the input that selects the generated background image.

17. A non-transitory computer-readable storage medium storing instructions that, when executed by at least one processor, cause the at least one processor to perform operations comprising:
receiving contextual data associated with a client device;
generating a prompt to a generative artificial intelligence (AI) model based on the contextual data and a parameterized prompt template;
providing the prompt to the generative AI model;
receiving, from the generative AI model, a generated background image based on the prompt; and
causing display of a graphical user interface (GUI) that comprises a display of a graphical avatar associated with the client device displayed upon the generated background image.

18. The non-transitory computer-readable storage medium of claim 17, wherein the generating the prompt comprises:
accessing the parameterized prompt template based on at least a portion of the contextual data; and
inserting the contextual data into corresponding fields of the parameterized prompt template.

19. The non-transitory computer-readable storage medium of claim 17, wherein the contextual data comprises:
location data that indicates a geographic location of the client device;
weather data associated with the geographic location, wherein the weather data indicates at least one of rain conditions, snow conditions, sun conditions, wind conditions, and smoke conditions; and
temporal data that indicates a current time of day at the geographic location.

20. The non-transitory computer-readable storage medium of claim 17, wherein the generated background image comprises a base image and a visual effect overlay, and wherein the receiving the generated background image comprises:
receiving the base image from the generative AI model;
accessing the visual effect overlay from a repository based on a portion of the contextual data; and
generating the generated background image based on the base image and the visual effect overlay.
